(19) United States
(12) Patent Application Publication
(10) Pub. No.: US 2017/0350724 A1
(43) Pub. Date: Dec. 7, 2017

(54) OFFSET DETECTION BETWEEN JOINED COMPONENTS

(71) Applicant: HARTING IT SOFTWARE DEVELOPMENT GMBH & CO. KG, Espelkamp (DE)

(72) Inventors: Paul Terentschenko, Espelkamp (DE); Rene Wermke, Laatzen (DE)

(21) Appl. No.: 15/540,967

(22) PCT Filed: Oct. 21, 2015
(86) PCT No.: PCT/EP2015/074381

§ 371 Date: Jun. 29, 2017

(30) Foreign Application Priority Data
Dec. 29, 2014 (DE) 10 2014 227 016.2
May 11, 2015 (DE) 10 2015 208 723.9

(51) Int. Cl. G01D 5/14; G01M 17/10

(52) U.S. Cl. CPC G01D 5/14; G01M 17/10

(57) ABSTRACT

The invention relates to a device, to a system, and to a method for detecting an offset between two joined, in particular pressure joined components during operation of said components and to the use of an RFID transponder for detecting an offset between two joined, in particular pressure joined components during operation of said components. In respect of the device, there is a first element, provided for attaching to one of the components, and a second element, provided for attaching to the other of the components, wherein the first and second element are coupled and/or can be coupled to each other across a joint of the components such that an offset influences the coupling, wherein the device furthermore has a transmission unit, which is designed to transmit a state and/or a dimension of the coupling without contact.

The invention relates to a device, a system, and to a method for detecting an offset between two joined, in particular pressure-joined components during operation of said components and to the use of an RFID transponder for detecting an offset between two joined, in particular pressure-joined components during operation of said components.

In the fields of power generation, traffic engineering and process engineering, designs are used which demonstrate classical applications of permanent and non-permanent connecting elements, such as shrink joints, welded joints, solder joints, glued joints, bolted joints, clamping joints, screwed joints, etc.. In the event of failure, these can have repercussions that are not only capital-intensive, but also of relevance for safety. In the field of passenger transport on rail vehicles, in particular, scenarios are conceivable in which the failure of connecting elements may also result in catastrophic situations up to and including derailment and personal injury.

In such cases or similar cases, approaches are therefore sought which allow unequivocal safeguarding of the mechanical integrity of machines and vehicles to be detected and signalled during ongoing operation.

One problem addressed by the invention shall be described below with reference to an example from the field of traffic engineering.

The example relates to a method and an apparatus for detecting permanent distortions such as those which can occur on the wheels of rail vehicles. This can affect the region between a rail vehicle wheel disc, in the form of a hub body, and a wheelset shaft, or the coupling between the wheel disc and the wheel tyre. In both cases, the components are connected to each other with a press fit.

In railway traction units, it is very important to monitor the wheelsets so as to be able to detect critical states at an early stage and take appropriate counter-measures. For example, it is important to detect distortion in interference fit assemblies, because axial displacements can occur in the event of a distortion with simultaneous occurrence of track track guiding forces—the gauge of the affected wheelset changes as a result, so the derailment safety of the vehicle is no longer safeguarded.

There is therefore a need for detecting, during ongoing operation of a rail vehicle, whether permanent distortion has occurred within the monitored shaft-hub connection of the wheelset shaft and wheel disc, or between the wheel disc and the wheel tyres.

Besides the detection of distortion, similar problems also exist in other contexts, or in other technical applications, with regard to the detection of lateral displacements, so the present invention may also relate to that aspect. This also includes crack formation.

In practice, distortion in the shaft-hub connection of a railway wheelset, for example, is only detected by visual inspection when the vehicle is at a standstill. This is done by applying circumferential markings to the joint between shaft and hub. These markings are aligned with other in the original state, but an offset between the markings develops after distortion arises. With this method, the earliest point at which it is possible to detect a change in the state of the wheelset is when the trip during which the damage has occurred has ended. This means that there is potentially dangerous condition for trips carried out after the distortion has occurred and until a visual inspection is conducted.

Several techniques for determining the rotational speed of rotating bodies are known. All these techniques are based on applying trigger markings to the rotating body, which trigger a sensor signal when they pass a stationary reference point. Depending on the number and type of trigger markings applied, it is also possible to detect the respective current angle of rotation, in addition to the rotational speed.

If the rotational speed of both the shaft and the hub are measured with this technique, then although any difference in rotational speeds that arises can be detected, a permanent distortion of the hub on the shaft cannot be detected, because the distortion is manifested momentarily—after rotation, the hub sits securely on the shaft again, and the two components subsequently rotate with identical speed.

A method for detecting changes in the relative angular position between the steel wear rings on a pair of rail vehicle wheels comprising two wheels secured to the ends of an axle is known from AT 15 268 E, in which each wear ring is provided with a magnetic pattern which is scanned by means of sensors. The relative angular positions of the two wear rings are determined by comparing the sensor signals in a comparator. However, it is not possible in this way to unambiguously detect the distortion of a wheel disc in relation to a wheel shaft.

Methods are also known (e.g. DE 102 19 057 A1), in which the current torsional moment in said shaft can be calculated by measuring the phase shift between two measuring discs on the same shaft. It is not possible with this application either to detect a permanent distortion between two components, since it is limited solely to one shaft.

WO 2011/029526 A1 describes a rail vehicle wheelset having two sensors mounted in relation to each other in the axial direction, with each sensor triggering an alternating signal pattern. A comparator compares the two sensor signals and generates an alarm as soon as the deviation between the two sensor signals exceeds a predefined threshold value. This method is used to monitor the wheelset shaft as such.

A invention is presented in DE 10 2011 113 844 B3, in which a phase angle between the wheel disc and the wheelset shaft is calculated in two directions of rotation by having a measuring point on the wheel disc trigger a sensor attached to a bearing housing, and by having a measuring point attached to the wheelset shaft trigger a sensor which is likewise attached to the bearing housing, and the phase angle is compared with a phase angle calibrated when taken into service, and in which a warning signal is emitted by a computing device when a distortion arises.

The subject-matter of DE 198 39 596 C2 is confined to detecting cracks in wheel cross-sections. In each wheel, crack sensors are arranged which are connected to a transmitter in the wheel and which conduct a signal via a receiver on the bogie to the traction unit and which trigger a visual or acoustic warning. The crack sensors consist of conductive, breakable but shock-resistant material, are rod-shaped and fixed with resin in moulded channels in the wheel disc. Any crack formation in the wheel or the wheel tyres causes the rod to break and signal transmission to stop. This is detected by an associated signal receiver, which transmits a coded signal to the traction unit as described above.

The aim of the invention is to provide a device, a system and a method for detecting an offset between two joined, in particular pressure-joined components during operation of said components, and to use an RFID transponder to detect an offset between two joined, in particular pressure-joined components during operation of said components, such that any offset can be detected reliably (with regard to false positives and false negative errors) with the most efficient possible use of resources (in particular at low cost), also during operation.

To that end, one aspect of the invention provides a device for detecting an offset between two joined, in particular pressure-joined components during operation of said components, said device comprising a first element for attachment to one of the components and a second element for attachment to the other of the components, wherein the first and second element are coupled and/or can be coupled to each other via a joining point of the components such that an offset influences the coupling, wherein the device further comprises a transmission unit which is designed to contactlessly transmit a state and/or a dimension of the coupling.

Another aspect of the invention provides a system for monitoring an offset between two joined, in particular pressure-joined components during operation of said components, said system comprising at least one device according to the invention for detecting the offset, a receiver unit which is adapted to receive a state of the coupling transmitted contactlessly by the transmission unit of a device and/or to receive a dimension of the coupling transmitted contactlessly by the transmission unit of a device and to output a corresponding signal, and an evaluation unit which is adapted to evaluate the offset between the components on the basis of a signal outputted by the receiver unit.

Another aspect of the invention provides a method for detecting an offset between two joined, in particular pressure-joined components during operation of said components, said method comprising the steps of attaching a first element to one of the components, attaching a second element to the other of the components, wherein the first and the second element are attached in such a way that the first and the second element are coupled and/or can be coupled to each other via a joining point of the components such that an offset influences the coupling, detecting a state and/or a dimension of the coupling and contactlessly transmitting the detected state and/or dimension of the coupling.

Yet another aspect of the invention provides a use of an RFID transponder for detecting an offset between two joined, in particular pressure-joined components during operation of said components, wherein the RFID transponder is attached over a joining point of the components, such that an offset between the components that exceeds a predetermined amount destroys the RFID transponder and/or modifies it in a predetermined manner such that a dimension of the offset can be seen from a signal response of the RFID transponder.

According to the invention, measurement of the offset between components is made possible by measuring the relationship between elements attached to the components. In that respect, it is not the offset between the components themselves that is measured or detected, but rather the offset between the coupled elements (or components of the RFID transponder) that is caused by the offset between the components.

One idea on which the invention is based is to enable any permanent distortions, displacements or the like that occur between connection elements to be detected in a general form, but with a cost-efficient approach. It can be assumed in this regard that monitoring must be carried out on many identical components. Monitoring is preferably conducted with the help of a passive wireless sensor, based on RFID (radio frequency identification) technology, for example.

One advantage of the invention is also that there is no need for complicated contacting for data transmission, for example via wear rings, between a rotating component and a stationary component.

In one embodiment of the invention, the transmission unit has a passive RFID transponder for contactless transmission.

Using RFID technology for contactless transmission allows prior art solutions for transmission to be utilised that satisfy high standards of reliability and cost efficiency, while also allowing solutions for receiving data to be used that can be easily integrated into operations.

In another embodiment of the invention, the coupling between the first and the second element has an electrical line which is adapted to be interrupted by an an offset which exceeds a predetermined amount.

The electrical line can be easily checked for the interruption indicating the offset that is considered to be impermissible or excessive. For example, the fragile electrical line itself may be part of a circuit of the transmission unit, with the result that any breakage in the line renders the transmission unit itself inoperative. A failure to respond to a request sent to the detection means can then be seen as indicating an offset that exceeds the predetermined amount. On the other hand, it is also possible that the line interruption is what causes a circuit to become ready for operation, such that a response to a request can also be seen as indicating the excessive offset. However, the electrical connection of the line, or the interruption of the line, can also be checked by an appropriate circuit and/or logic in the device itself, so that the respective state can be outputted from the transmission unit.

In one variant of this embodiment, the coupling comprises a plurality of electrical lines which are each designed to be interrupted in the event of an offset which exceeds a different associated amount.

When using different lines having different sensitivities and which are preferably connected in parallel, it is possible to specify gradations of the offset which allow an early response and/or an offset trend to develop.

It is possible with the previously described lines that the offset (or its exceeding a limit) causes destruction (e.g. ripping) of the line itself, with the result that the interruption is then permanent. However, the invention also covers a situation in which the interruption is merely temporary insofar as the parts of the line can be reassembled and the interruption removed once the offset has been reset (to a value lower than the threshold value at least). In this case, the line can be considered a reversible switch.

When using an electrical line, different embodiments can be implemented. Besides one variant in the form of an electrically conductive wire, it is also possible to use suitably adapted conductive metal sheets, which provide advantages during assembly, in the reproducibility of the interruption function and in a clear response even to the smallest angles of distortion or offsets.

In one implementation, a design is provided which has a geometrically defined constriction which serves as a breaking point. The planar shape of the sheet metal variant is favourable for large adhesive surfaces, which ensure that any shear forces that arise in the event of an offset are definitely conducted through said breaking point and therefore trigger the interruption in a targeted manner.

The advantages of using a metal sheet as part of the electrical line can best be realised when the metal sheet is exactly machined, preferably with spatial alignment with the surface contours present on the two components. When using glue to bond the metal sheet to the components, appropriate mechanical/chemical preparation of the adhesive surfaces is also important for the long-term stability of the attached indicator, in the form of the metal sheet.

As an alternative or in addition to the electrical line as described above, which is designed to be interrupted by an offset which exceeds a predetermined amount, the coupling may have electrically conductive parts which can be brought into contact with each other by an offset which exceeds a predetermined amount.

When this approach is taken, the observations above regarding interruption of the line apply accordingly.

In another variant, the coupling has three or more electrically conductive parts, of which at least two can be brought into contact with each other by an offset which exceeds a predetermined amount.

There are many ways of combining the conductive parts with each other. For example, a contact may be provided as a conductive part on one element, wherein at a given offset said contact occupies a position in which the contact establishes a connection between two conductive parts of the other element. Another option is to provide one element with a conductive part opposite a plurality of individual conductive parts on the other element, such at an electrical line is formed in each case by the one conductive part and by a particular conductive part of the other element at different offsets (or also when there is no offset).

The approaches involving interrupting an electrical line and closing an electrical line can also be combined with each other.

In another embodiment, the coupling between the first and the second element comprises a coupling via an electrical, magnetic and/or electromagnetic field.

The coupling, and using it to determine or detect an offset, does not require any electrical contact between the elements.

It is possible, in particular, to use an electrical, a magnetic and/or an electromagnetic field to determine or detect the offset when said field or fields are deployed in such a way that a relative movement between the elements (or the result thereof) is made discernible.

In one variant of this embodiment, the first element has a Reed switch and the second element has a magnet and/or a magnetic coil.

The Reed switch responds sensitively to an approaching magnet or to the presence of a magnetic field, the relative position between the elements causing the Reed switch to either remain open or to be closed. In one variant, the magnet or magnetic coil is arranged in such a way that the Reed switch is not opened until there is an excessive offset, so the closed switch can also be used to perform a functional test. In a more complex arrangement, the magnetic coil itself can be controlled to open and close the Reed switch even without an offset, so that it is possible to perform a functional test that is more complete.

In another variant of the above embodiment, the first element and the second element each have each have one coil from a pair of coils, and/or the first element and the second element each have an electrode of a capacitor, and/or the first element and the second element have an antenna and a parasitic antenna element.

In a coil pair, the offset can be accessed via an inductive coupling that is dependent on the spacing between the coils. The characteristics of the capacitor likewise depend on the gap between the electrodes, so it possible here also to measure an offset using simple means. The relative position of the antenna and the parasitic antenna element also affect the characteristics of the antenna (e.g. its foot impedance).

In another embodiment, the coupling between the first and the second element comprises a strain gauge which is designed in particular for arrangement along and/or transverse to the offset direction.

A strain gauge allows measurements to be carried out in a simple and at least basically stepless manner, so it is possible here also to track the offset during the operating time. Due to quantitative specification, a plurality of “alarm levels” or a set of measures can also be provided, which can likewise have continuous aspects based on what the strain gauge indicates.

If two substantially identical strain gauges are attached, the one being more sensitive to the offset and the other being substantially insensitive to the offset, it is possible to compensate for the effect of temperature, for example, since the effect of the offset obtained by comparing the signals from the strain gauges may differ from the effect of temperature.

Preferred embodiments of the invention are defined in the dependent claims, in particular. It should be understood in that regard that the device according to the invention, the system according to the invention, the method according to the invention and the use according to the invention have similar and/or identical preferred embodiments. Other preferred embodiments ensue by combining the individual dependent claims, if and insofar as the different embodiments and variants can be combined with each other.

The invention shall now be described with reference to the embodiments and to the enclosed Figures, in which

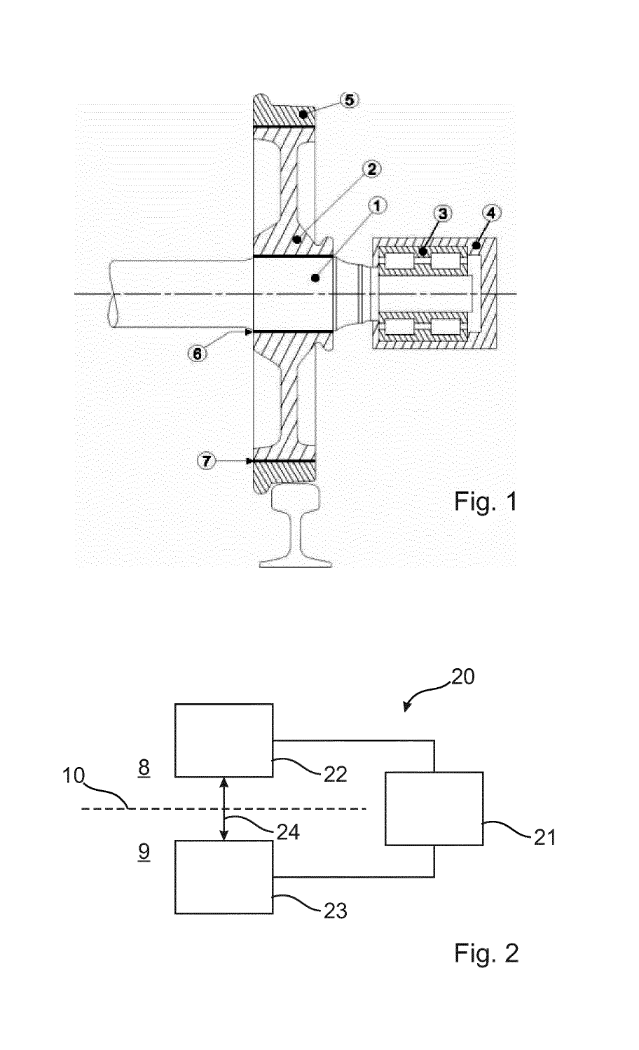

FIG. 1 shows a schematic view of a wheelset fitted with wheel tyres, in which the present invention can be deployed,

FIG. 2 shows a schematic view of a first embodiment of the device according to the invention,

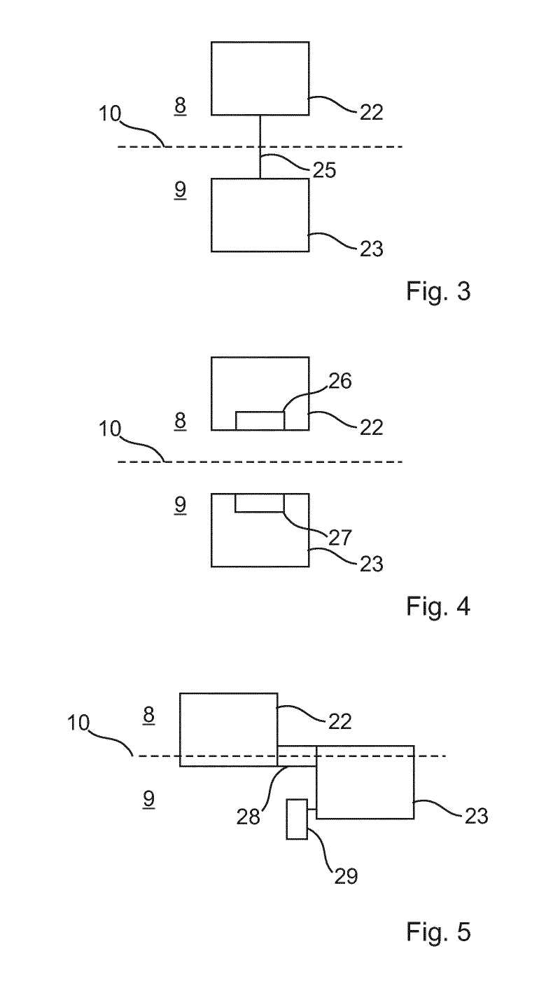

FIG. 3 shows a schematic view of one aspect of a second embodiment of the device according to the invention,

FIG. 4 shows a schematic view of one aspect of a third embodiment of the device according to the invention,

FIG. 5 shows a schematic view of one aspect of a fourth embodiment of the device according to the invention,

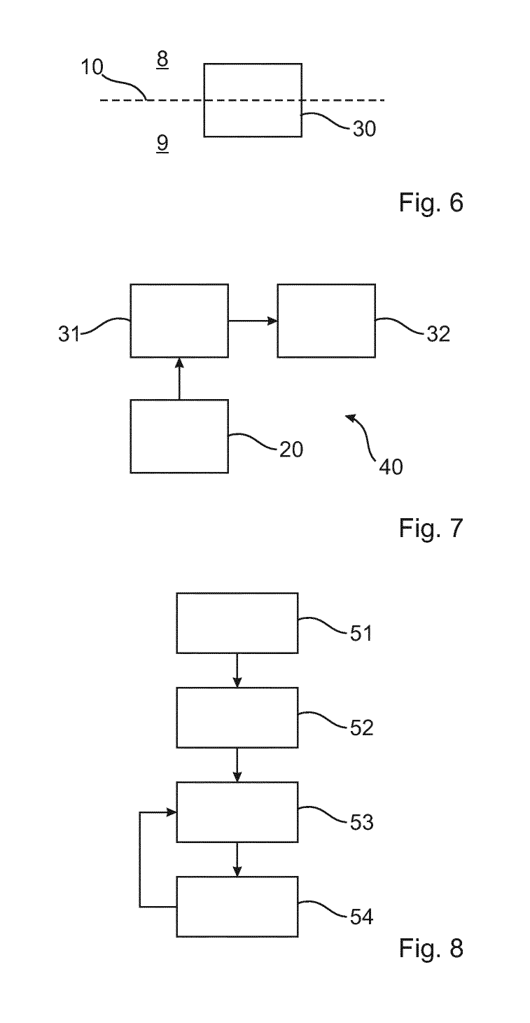

FIG. 6 shows a schematic flow diagram of an embodiment of the use according to the invention,

FIG. 7 shows a schematic view of an embodiment of the system according to the invention,

FIG. 8 shows a flow diagram of an embodiment of the method according to the invention,

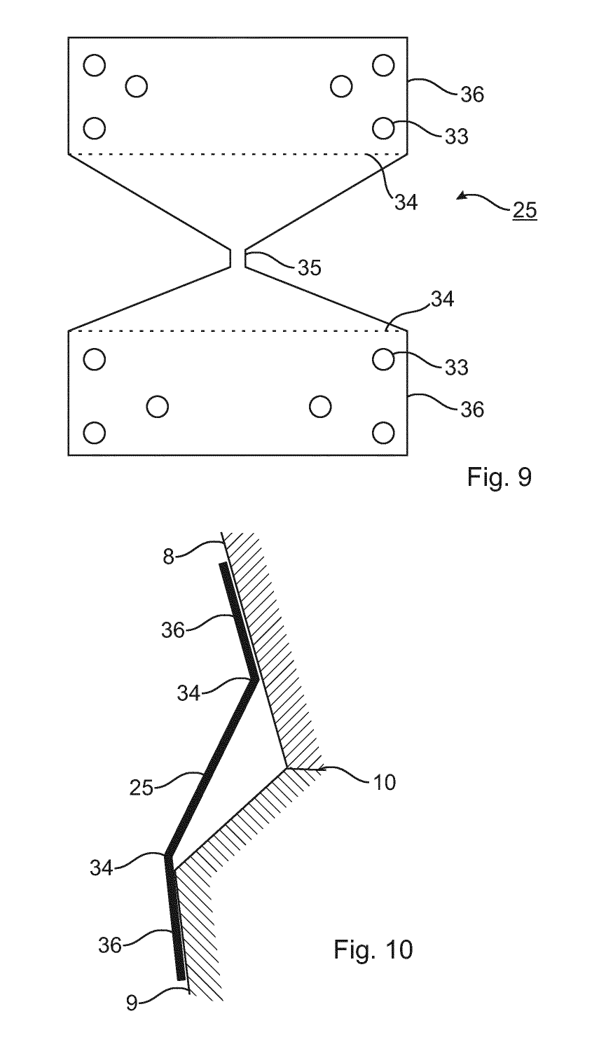

FIG. 9 shows a schematic view of a conductive metal plate, as an example of an electrical line and showing one aspect of the second embodiment of the device according to the invention and

FIG. 10 shows a schematic cross-sectional view of the metal plate in FIG. 9, on two components.

FIG. 1 shows a schematic view of a wheelset fitted with wheel tyres, in which the present invention can be deployed.

A wheel disc 2 is pressed onto wheelset shaft 1. Wheelset shaft 1 is mounted via a rolling bearing 3 in a bearing housing 4. A wheel tyre 5 is pressed onto wheel disc 2. This means there are two press fits: a first press fit 6 between wheelset shaft 1 and wheel disc 2, and a second press fit 7 between wheel disc 2 and wheel tyre 5.

Said press fits 6, 7 can be checked and monitored during operation for an offset by means of a device according to the invention and with a corresponding method according to the invention.

FIG. 2 shows a schematic view of a first embodiment of the device according to the invention.

A device according to the invention 20 is arranged in such a way on two components 8, 9, which are joined by a press fit 10, for example, that a change in device 20 occurs when distortion or displacement occurs between the pair of components. Device 20 comprises an RFID transponder 21 which performs higher-level functions in additional to the known capability of storing data. Said transponder 21 is connected in a sensor arrangement to a first element 22, a second element 23 and to a coupling 24 between said elements 22, 23. The RFID transponder detects the current state of the sensor arrangement, and any change in that state, and passes the information wirelessly by radio to an RFID reader (not shown here, see FIG. 7).

Device 20, comprising transponder 21 and a sensor arrangement connected thereto, operates in passive mode, i.e. the transponder draws its energy from the radiation field of the RFID reader. Device 20 is therefore maintenance-free.

The state detected by the sensor is read out, for example, when passing by a plurality of defined measuring stations each equipped with an RFID reader.

In an advantageous practical implementation, the following technical features ensue for the device:

The transponder is a passive component of robust design so that it monitors the prevailing environmental conditions, in the form of temperature, shocks, centrifugal forces, humidity, water splashes, chemical solvents, effects of foreign matter and EMC effects, without functional limitations.

The sensor arrangement is arranged in such a way over the potential separation point that it changes or loses contact in the event of distortional movements or displacements. This can be interpreted as a measure of divergence.

The sensor arrangement, and its coupling 24, may be a break sensor, for example, which interrupts an electrically conductive connection in the event of any displacement or distortional movement. Another possible form involves the use of a Reed relay mounted on the one side of the press fit, and a magnetic counterpart on the opposite side of the press fit, which opens and closes its contact in response to the magnet being distorted.

The sensor arrangement is thus attached to both of the components to be monitored (e.g. by gluing, clamping, stapling, screwing, embedding, etc.), in such a way that any mechanical change (displacement or distortional movement) causes a change in the state of the sensor arrangement and concomitantly in the transponder signal.

When the transponder passes an RFID reader, a transponder identifier (ID) uniquely associated with the vehicle/wheelset or wheel is read out and stored, in addition to the sensor status.

Any changes or failures in the transponder identifier allow conclusions to be drawn abut changes in the mechanical integrity of the monitored components and trigger the respective control and repair measures in respect of the object in question.

For the sake of clarity and simplicity, only elements 22, 23 of the device, and the coupling via the point of separation 10 of components 8, 9, are shown in in FIGS. 3-5.

FIG. 3 shows a schematic view of one aspect of a second embodiment of the device according to the invention.

Elements 22, 23 are attached respectively to one of components 8, 9, elements 22, 23 being coupled to one another by an electrical line 25 in the form of a wire, for example, or a shaped metal plate (see FIGS. 9 and 10 below). If an offset between components 8, 9 occurs (i.e. a relative displacement between the components, to the left or right in the view shown in FIG. 3) wire 25 or metal plate 25 is destroyed.

FIG. 4 shows a schematic view of one aspect of a third embodiment of the device according to the invention.

In this aspect also, elements 22, 23 are mounted on components 8, 9, namely in such a way, in a state without any offset (as shown here), that a Reed switch 26 of element 22 is located opposite a magnet 27 of element 23.

When components 8, 9 move relative to each other along press fit 10, in other words when an offset ensues, magnet 27 is moved away from Reed switch 26, which is then opened so that the offset becomes discernible for the device.

FIG. 5 shows a schematic view of one aspect of a fourth embodiment of the device according to the invention.

Elements 22, 23 are connected to each other by a strain gauge 28 and are mounted on components 8, 9 in such a way that one element 22, 23 is securely joined (e.g. glued) in each case to one of components 8, 9. A respective part of elements 22, 23 extends into the region of the respective other component 8, 9, but it is not attached there. Strain gauge 28 is attached to elements 22, 23 only, but not to components 8, 9. In this aspect, additionally, there is another strain gauge 29 which is not involved directly in detecting the offset. Given that temperature variations and other influences can jointly act on strain gauges 28, 29, the offset, which merely acts on strain gauge 28, can be determined from the difference in signals from strain gauges 28, 29.

FIG. 6 shows a schematic view of an embodiment of the use according to the invention.

An RFID transponder 30 is securely joined by a press fit 10 (as an example of a joint) between two components 8, 9 to said two components 8, 9, for example by gluing.

Any offset exceeding a predetermined amount and arising between components 8, 9 will destroy RFID transponder 30. The respective offset can be concluded from the fact that a response to a request no longer occurs.

Alternatively, the offset can modify the RFID transponder in a predetermined manner such that a measure of the offset can be derived from a signal response of the RFID transponder. This may also be based on partial destruction of the RFID transponder, for example by selective ripping of a part of the RFID transponder without doing away with its overall function.

FIG. 7 shows a schematic view of an embodiment of the system according to the invention.

In practice, system 40 comprises a plurality of devices 20 according to the invention, a plurality of receiver units 31 which each receive a state of the coupling transmitted contactlessly by the transmission unit of device(s) 20 and/or which each receive a measure of the coupling transmitted contactlessly by the transmission unit of devices (20) and output a corresponding signal, and a plurality of evaluation units 32 which evaluate the offset between the components on the basis of a signal received from the receiver unit (only one of each shown here).

In one implementation in which the transmission unit is an RFID transponder, the receiver unit can be considered an RFID reader 31.

Data handling is based on the state at the transponder being read out by means of an antenna connected to reader 31. The reader/antenna unit can be installed on the vehicle and travel with it, or may be in the form of a fixed, stationary installation.

A local computer unit 32 which associates the states at the transponders, in combination with the specific transponder ID, with the individual vehicles, bogies, wheelsets and wheels, and transfers the resultant data to a respective database. When a plurality of readers 31 are used, local computer units 32 are connected in a network (not shown) and pass the fetched states directly to a central computer unit (not shown), on which they are then assigned accordingly and entered in a database.

Parallel to their detection, the respective states are analysed. Potential distortions and missing transponders are indicated, for example by a relay signal.

False alarms based on fully transmitted data packets are precluded due to binary detection of states. However, in order to prevent false reports due to incomplete or untransmitted data packets, several read-out cycles with an identical result (i.e. the detection of an offset) are preferably required before an alarm signal is given.

FIG. 8 shows a flow diagram of an embodiment of the method according to the invention.

The method for detecting an offset between two components firstly comprises a first attachment step 51 in which a first element is attached to one of the components and a second attachment step 52 in which a second element is attached to the other of the components. The first and the second elements are attached in such a way that the first and the second elements are coupled to each other via a joining point of the components in such a way that an offset affects the coupling. In the following detection step 53, a state and/or a measure of the coupling is detected, wherein the detected state and/or measure of the coupling is contactlessly transmitted in a transmission step 54. The transmission may also include a negative statement, for example in the form that transmission continues as long as the predetermined offset has not yet occurred, whereas occurrence of the predetermined offset results, for example due to destruction of the device, to no further transmission being carried out.

FIG. 9 shows a schematic view of a conductive metal plate as an example of an electrical line, as one aspect of the second embodiment of the device according to the invention.

As already noted above with reference to FIG. 3, the electrical line, breakage of which indicates an offset exceeding a predetermined amount, can also be realised by a suitably shaped metal plate.

Such a metal plate 25 is shown in FIG. 9. Metal plate 25 has two planar attachment regions 36, which are shown here with holes 33 for rivets or the like. Instead of, or in addition to such a mechanical connection, attachment regions 36 may also be glued to the components (see FIG. 10). In this case, holes 33 may serve as assembly aids or to ensure a non-conductive connection to the respective component.

Between attachment regions 36, metal plate 25 has a constriction 35 at which the cross-section of the metal plate is reduced to such an extent that an offset between attachment regions 36 (and thus between the components) results in breakage at the constriction and thus to the electrical line being interrupted.

In the case shown here, the direction of the offset is transverse to constriction 35 (see FIG. 10), although other orientations are also possible, however.

Metal plate 25 has two kinks 34, as also shown in FIG. 10. Metal plate 25 is not limited, therefore, to cases in which the components are arranged in alignment with each other. However, this example is not to be understood as a limitation, because other shapes of metal plate are also possible in order to adapt metal plate 25 to the geometry of the components. In particular, it is not necessarily the case that the parts of the metal plate are planar as such, because attachment regions 36, above all, can be adapted to the contours of the components (either by previous shaping or not until they are being attached).

FIG. 10 shows a schematic cross-sectional view of metal plate 25 from FIG. 9 on two components 8, 9. Components 8, 9 have a joining point 10, and metal plate 25 is attached to components 8, 9 with the aid of attachment regions 36 in such a way that intermediate region and in particular the construction (not shown in FIG. 10) extend over the joining point.

Fastening regions 36 abut components 8, 9 at least partially, and metal plate 25 has kinks 34 such that metal plate 25 as a whole basically follows the contour of combined components 8, 9.

In particular, kinks 34 (or other regions of metal plate 25) may be under mechanical tension when installed. If the tension in the two kinks 34 acts in the same direction, or also if it acts in opposite directions, the respective tension is removed in the event of the constriction breaking, in which case the breaking points move away from each other as a result of the tension being removed. For example, the individual parts between kinks 34 and separated from each other as a result of the break, could move in the clockwise or anti-clockwise direction (in FIG. 10), in order to produce additional so spatial separation in the event of the constriction breaking.

1. A device for detecting an offset between two joined, in particular pressure joined components during operation of said components, comprising:
a first element, which is provided for attaching to one of the components, and a second element, which is provided for attaching to the other of the components,
wherein the first and the second element are coupled and/or can be coupled to each other via a joining point of the components such that an offset influences the coupling,
wherein the device furthermore has a transmission unit, which is designed to transmit a state and/or a dimension of the coupling without contact.

2. The device according to claim 1,
wherein the transmission unit has a passive RFID transponder for contactless transmission.

3. The device according to claim 1,
wherein the coupling between the first and the second element has an electrical line, which is designed to be interrupted by an offset which exceeds a predetermined amount, and/or wherein the coupling has electrically conductive parts which can be brought into contact with each other by an offset which exceeds a predetermined amount.

4. The device according to claim 3,
wherein the electrical line has a conductive metal plate with two attachment regions for respective attachment to one of the components, and a constriction located between the attachment regions, wherein the constriction is designed to break in the event of an offset which exceeds a predetermined amount.

5. The device according to claim 3,
wherein the coupling comprises a plurality of electrical lines which are each designed to be interrupted in the event of an offset which exceeds a different associated amount.

6. The device according to claim 2,
wherein the coupling has three or more electrically conductive parts, of which at least two can be brought into contact with each other by an offset which exceeds a predetermined amount.

7. The device according to claim 1,
wherein the coupling between the first and the second element comprises a coupling via an electrical, magnetic and/or electromagnetic field.

8. The device according to claim 7,
wherein the first element has a Reed switch and the second element has a magnet and/or a magnetic coil.

9. The device according to claim 7, wherein the first element and the second element each have one coil from a pair of coils, and/or
the first element and the second element each have an electrode of a capacitor,
and/or
the first element and the second element have an antenna and a parasitic antenna element.

10. The device according to claim 1,
wherein the coupling between the first and the second element comprises a strain gauge which is designed in particular for arrangement along and/or transverse to the offset direction.

11. A system for monitoring an offset between two joined, in particular pressure-joined components during operation of said components, comprising:
at least one device for detecting an offset, according to claim 1,
a receiver unit, which is adapted to receive a state of the coupling transmitted contactlessly by the transmission unit of a device and/or to receive a dimension of the coupling transmitted contactlessly by the transmission unit of a device and to output a corresponding signal, and
an evaluation unit, which is adapted to evaluate the offset between the components on the basis of a signal outputted by the receiver unit.

12. A method for detecting an offset between two joined, in particular to pressure-joined components during operation of said components, comprising the steps of:
attaching a first element to one of the components,
attaching a second element to the other of the components, wherein the first and the second element are attached in such a way that the first and the second element are coupled and/or can be coupled to each other via a joining point of the components such that an offset influences the coupling, detecting a state and/or a dimension of the coupling and contactlessly transmitting the detected state and/or dimension of the coupling.

13. A method for detecting an offset between two joined, in particular pressure-joined components during operation of said components, wherein an RFID transponder is attached over a joining point of the components, such that an offset between the components that exceeds a predetermined amount destroys the RFID transponder and/or modifies it in a predetermined manner such that a dimension of the offset can be seen from a signal response of the RFID transponder.

14. The device according to claim 2,
wherein the coupling between the first and the second element has an electrical line, which is designed to be interrupted by an offset which exceeds a predetermined amount, and/or wherein the coupling has electrically conductive parts which can be brought into contact with each other by an offset which exceeds a predetermined amount.

15. The device according to claim 14,
wherein the electrical line has a conductive metal plate with two attachment regions for respective attachment to one of the components, and a constriction located between the attachment regions, wherein the constriction is designed to break in the event of an offset which exceeds a predetermined amount.

16. The device according to claim 14,
wherein the coupling comprises a plurality of electrical lines which are each designed to be interrupted in the event of an offset which exceeds a different associated amount.

17. The device according to claim 3,
wherein the coupling has three or more electrically conductive parts, of which at least two can be brought into contact with each other by an offset which exceeds a predetermined amount.
